(19) United States
(12) Patent Application Publication
(10) Pub. No.: US 2009/0225465 A1
(43) Pub. Date: Sep. 10, 2009

(54) Magnetic recording head and magnetic recording apparatus

(75) Inventors: Hitoshi Iwasaki, Kanagawa-ken (JP); Kenichiro Yamada, Tokyo (JP); Junichi Akiyama, Kanagawa-ken (JP); Masayuki Takagishi, Tokyo (JP); Tomomi Funayama, Saitama-ken (JP); Masahiro Takashita, Kanagawa-ken (JP); Mariko Shimizu, Kanagawa-ken (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/232,014

(22) Filed: Sep. 9, 2008

(30) Foreign Application Priority Data
Sep. 11, 2007 (JP) 2007-235114

(51) Int. Cl. G11B 21/02; G11B 5/33

(52) U.S. Cl. 360/75; 360/324; G9B/5.104; G9B/21.003

(57) ABSTRACT

A magnetic recording head includes a main magnetic pole, and a laminated body. The laminated body includes a first magnetic layer, a second magnetic layer, a first intermediate layer provided between the first magnetic layer and the second magnetic layer, and a third magnetic layer laminated with the first and second magnetic layers and the first intermediate layer. The third magnetic layer exerts a magnetic field on at least any of the first magnetic layer and the second magnetic layer. The third magnetic layer has larger saturation magnetization than at least any of the first magnetic layer and the second magnetic layer.

### CROSS-REFERENCE TO RELATED APPLICATIONS

This application is based upon and claims the benefit of priority from the prior Japanese Patent Application No. 2007-235114, filed on Sep. 11, 2007; the entire contents of which are incorporated herein by reference.

### BACKGROUND OF THE INVENTION

1. Field of the Invention

This invention relates to a magnetic recording head and a magnetic recording apparatus provided with a spin torque oscillator generating a high-frequency magnetic field.

2. Background Art

In the 1990s, the practical application of MR (magnetoresistive effect) heads and GMR (giant magnetoresistive effect) heads triggered a dramatic increase in the recording density and recording capacity of HDD (hard disk drive). However, in the early 2000s, the problem of thermal fluctuations in magnetic recording media became manifest, and hence the increase of recording density temporarily slowed down. Nevertheless, perpendicular magnetic recording, which is in principle more advantageous to high-density recording than longitudinal magnetic recording, was put into practical use in 2005. It serves as an engine for the increase of HDD recording density, which exhibits an annual growth rate of approximately 40% these days.

Furthermore, the latest demonstration experiments have achieved a recording density exceeding 400 Gbits/inch². If the development continues steadily, the recording density is expected to achieve 1 Tbits/inch² around 2012. However, it is considered that such a high recording density is not easy to achieve even by using perpendicular magnetic recording because the problem of thermal fluctuations becomes manifest again.

As a recording scheme possibly solving the above problem, the “high-frequency magnetic field assisted recording scheme” is proposed. In the high-frequency magnetic field assisted recording scheme, a high-frequency magnetic field near the resonance frequency of the magnetic recording medium, which is sufficiently higher than the recording signal frequency, is locally applied. This produces resonance in the magnetic recording medium, which decreases the coercivity (Hc) of the magnetic recording medium subjected to the high-frequency magnetic field to less than half the original coercivity. Thus, superposition of a high-frequency magnetic field on the recording magnetic field enables magnetic recording on a magnetic recording medium having higher coercivity (Hc) and higher magnetic anisotropy energy (Ku) (e.g., U.S. Pat. No. 6,011,664, hereinafter referred to as Patent Document 1). However, the technique disclosed in Patent Document 1 uses a coil to generate a high-frequency magnetic field, and it is difficult to efficiently apply a high-frequency magnetic field during high-density recording.

A technique based on a spin torque oscillator is proposed as a means for generating a high-frequency magnetic field (e.g., US Patent Application Publication No. 2005/0023938, hereinafter referred to as Patent Document 2). In the technique disclosed in Patent Document 2, the spin torque oscillator comprises an oscillation layer, an intermediate layer and a spin injection layer. It is proposed that injection of a polarized spin current from the spin injection layer to the oscillation layer produces high-frequency oscillation of a few tens of GHz band in the magnetization of the oscillation layer. Furthermore, it is reported that laminating a bias layer having a large perpendicular magnetic anisotropy on the oscillation layer made of FeCo alloy with Bs=2.5 T can produce high-frequency oscillation of a feq tens of GHz and generate a strong high-frequency magnetic field of 3 kOe (e.g., J. Zhu et al., TMRC2007, B8, hereinafter referred to as Non-Patent Document 1).

### SUMMARY OF THE INVENTION

According to an aspect of the invention, there is provided a magnetic recording head including: a main magnetic pole; and a laminated body including: a first magnetic layer, a second magnetic layer, a first intermediate layer provided between the first magnetic layer and the second magnetic layer, and a third magnetic layer laminated with the first and second magnetic layers and the first intermediate layer, the third magnetic layer exerting a magnetic field on at least any of the first magnetic layer and the second magnetic layer, the third magnetic layer having larger saturation magnetization than at least any of the first magnetic layer and the second magnetic layer.

According to still another aspect of the invention, there is provided a magnetic recording head including: a main magnetic pole; and a laminated body including a first magnetic layer, a second magnetic layer, a first intermediate layer provided between the first magnetic layer and the second magnetic layer, and a third magnetic layer and a fourth magnetic layer provided to sandwich the first magnetic layer and the second magnetic layer on both sides, the third magnetic layer and the fourth magnetic layer having larger saturation magnetization than at least any of the first magnetic layer and the second magnetic layer.

According to another aspect of the invention, there is provided a magnetic recording apparatus including: a magnetic recording medium; a magnetic recording head including: a main magnetic pole; and a laminated body including: a first magnetic layer, a second magnetic layer, a first intermediate layer provided between the first magnetic layer and the second magnetic layer, and a third magnetic layer laminated with the first and second magnetic layers and the first intermediate layer, the third magnetic layer exerting a magnetic field on at least any of the first magnetic layer and the second magnetic layer, the third magnetic layer having larger saturation magnetization than at least any of the first magnetic layer and the second magnetic layer; a moving mechanism configured to allow relative movement between the magnetic recording medium and the magnetic recording head which are opposed to each other with a spacing therebetween or in contact with each other; a controller configured to position the magnetic recording head at a prescribed recording position of the magnetic recording medium; and a signal processing unit configured to perform writing and reading of a signal on the magnetic recording medium by using the magnetic recording head.

According to still another aspect of the invention, there is provided a magnetic recording apparatus including: a magnetic recording medium; a magnetic recording head including: a main magnetic pole; and a laminated body including a first magnetic layer, a second magnetic layer, a first intermediate layer provided between the first magnetic layer and the second magnetic layer, and a third magnetic layer and a fourth magnetic layer provided to sandwich the first magnetic layer and the second magnetic layer on both sides, the third magnetic layer and the fourth magnetic layer having larger saturation magnetization than at least any of the first magnetic layer and the second magnetic layer; a moving mechanism configured to allow relative movement between the magnetic recording medium and the magnetic recording head which are opposite to each other with a spacing therebetween or in contact with each other; a controller configured to position the magnetic recording head at a prescribed recording position of the magnetic recording medium; and a signal processing unit configured to perform writing and reading of a signal on the magnetic recording medium by using the magnetic recording head.

### BRIEF DESCRIPTION OF THE DRAWINGS

FIG. 1 is a perspective view showing the schematic configuration of a magnetic recording head according to an embodiment of the invention;

FIG. 2 is a perspective view showing a head slider on which the magnetic recording head is mounted;

FIG. 3 is a perspective view showing the schematic configuration of a spin torque oscillator 11 provided in this magnetic recording head;

FIG. 4 is a schematic view illustrating the structure of a laminated body laminating an auxiliary bias layer 111 on the spin torque oscillator 11 shown in FIG. 3;

FIG. 5 is a schematic view illustrating the structure of a laminated body laminating an auxiliary bias layer 117 on the spin torque oscillator 11 shown in FIG. 3;

FIG. 6 is a perspective view showing the schematic configuration of the spin torque oscillator 11 according to this embodiment provided with a shield 62;

FIGS. 7A and 7B are schematic views illustrating the structure of a laminated body of a spin torque oscillator according to a comparative example;

FIG. 8 is a schematic view illustrating the structure of a laminated body of a spin torque oscillator 11 according to a second embodiment of the invention;

FIG. 9 is a schematic view illustrating the structure of a laminated body of the spin torque oscillator 11 according to the second embodiment of the invention;

FIG. 10 is a schematic view illustrating the structure of a laminated body of a spin torque oscillator 11 according to a third embodiment of the invention;

FIG. 11 is a principal perspective view illustrating the schematic configuration of a magnetic recording/reproducing apparatus;

FIG. 12 is an enlarged perspective view of a magnetic head assembly ahead of an actuator arm 155 as viewed from the disk side;

FIG. 13 is a schematic view Illustrating a magnetic recording medium that can be used in this embodiment; and

FIG. 14 is another schematic view Illustrating a magnetic recording medium that can be used in this embodiment.

### DETAILED DESCRIPTION OF THE INVENTION

Embodiments of the invention will now be described with reference to the drawings.

A first embodiment of a microwave assisted magnetic head of the invention is described in the case of recording on a multiparticle medium for perpendicular magnetic recording.

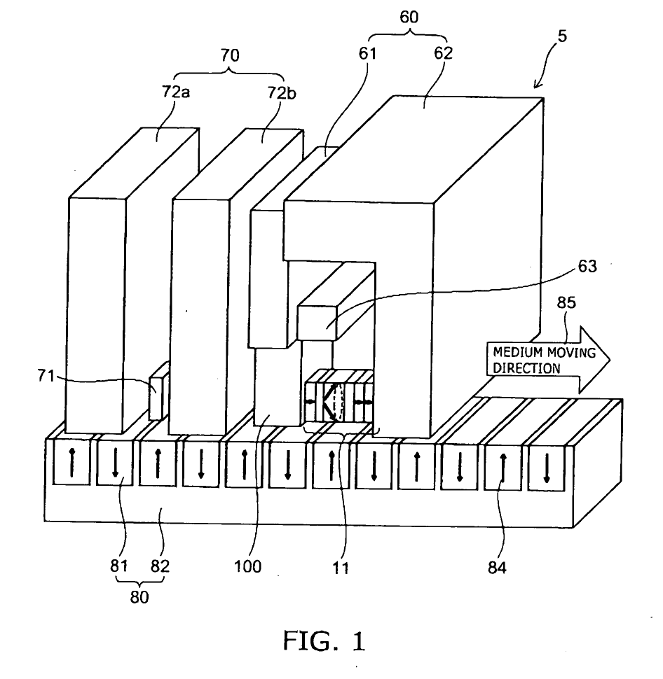

FIG. 1 is a perspective view showing the schematic configuration of a magnetic recording head 5 according to the embodiment of the invention.

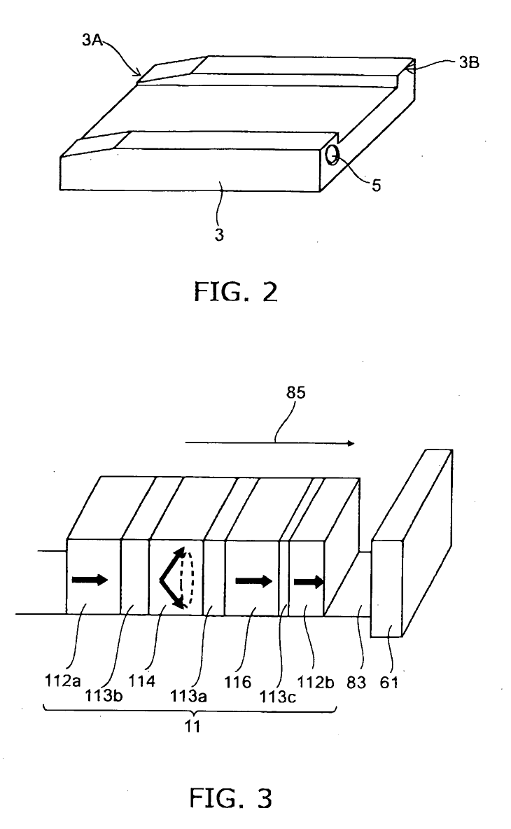

FIG. 2 is a perspective view showing a head slider on which the magnetic recording head 5 is mounted.

The magnetic recording head 5 of this embodiment comprises a reproducing head section 70 and a writing head section 60. The reproducing head section 70 comprises a magnetic shield layer 72a, a magnetic shield layer 72b, and a magnetic reproducing device 71 provided between the magnetic shield layer 72a and the magnetic shield layer 72b.

The writing head section 60 comprises a main magnetic pole 61, a return path (shield) 62, an excitation coil 63, and a spin torque oscillator 11. The components of the reproducing head section 70 and the components of the writing head section 60 are separated from each other by alumina or other insulators, not shown. The magnetic reproducing device 71 can be a GMR device or a TMR (tunnel magnetoresistive effect) device. In order to enhance reproducing resolution, the magnetic reproducing device 71 is placed between the two magnetic shield layers 72a and 72b.

The magnetic recording head 5 is mounted on a head slider 3 as shown in FIG. 2. The head slider 3, illustratively made of Al₂O₃/TiC, is designed and worked so that it can move relative to a magnetic recording medium 80 such as a magnetic disk while floating thereabove or being in contact therewith. The head slider 3 has an air inflow side 3A and an air outflow side 3B, and the magnetic recording head 5 is disposed illustratively on the side surface of the air outflow side 3B.

The magnetic recording medium 80 has a medium substrate 82 and a magnetic recording layer 81 provided thereon. The magnetization of the magnetic recording layer 81 is controlled to a prescribed direction by the magnetic field applied by the writing head section 60, and thereby writing is performed. The reproducing head section 70 reads the direction of magnetization of the magnetic recording layer 81.

FIG. 3 is a perspective view showing the schematic configuration of the spin torque oscillator 11 provided in this magnetic recording head.

The main magnetic pole 61 and a recording track 83 in the magnetic recording medium 80 are illustratively shown.

The spin torque oscillator 11 has a structure in which a bias layer 112a (third magnetic layer), an intermediate layer 113b (second intermediate layer), an oscillation layer 114 (first magnetic layer), an intermediate layer 113a (first intermediate layer), an spin injection layer (second magnetic layer), an intermediate layer 113c and a bias layer 112b (fourth magnetic layer) are laminated in this order. The bias layers 112a and 112b can serve as electrodes. By passing a driving electron current through the spin torque oscillator 11 via the electrodes, a high-frequency magnetic field can be generated from the oscillation layer 114. The driving current density is preferably from 5×10⁷ A/cm² to 1×10⁹ A/cm², and suitably adjusted so as to achieve a desired oscillation.

While a case of providing both bias layers 112a and 112b is described, any one of them may be provided. When the bias layer 112b on the spin injection layer 116 side is only provided, the intermediate layer 113c between the spin injection layer 116 and the bias layer 112b can be omitted.

The oscillation layer 114 is made of material having weak magnetic anisotropy and the magnetic anisotropy energy is preferably Ku<1×10⁶ erg/cm³. A saturation magnetic flux density is preferably Bs<2.0 T. Materials can be based on a CoFe alloy (Fe: 0˜30 at %), a CoFe (Fe: 0˜30 at %)/NiFe alloy laminated body or a NiFeCo alloy. Compared with a FeCo alloy having a high Fe concentration and high Bs, Bs is reduced and a high-frequency magnetic field strength per unit film thickness decreases, however, increasing a film thickness allows the whole high-frequency magnetic field strength to be set comparative to the case where a FeCo alloy is used, and the enough high-frequency magnetic field strength to be obtained. The film thickness of the oscillation layer 114 is preferably thick in terms of ensuring the high-frequency magnetic field strength, however, since a driving current necessary for the oscillation increases, there exist an optimum value. The product of Bs of the oscillation layer and the film thickness is preferably in the range of 10 nm·T to 40 nm·T. The thickness is preferably from 5 nm to 20 nm.

The spin injection layer 116 is made of material having strong perpendicular magnetic anisotropy and the magnetic anisotropy energy is preferably Ku>1×10⁶ erg/cm³. Materials can be based on laminated structure materials such as [Co(0.2˜2 nm)/Pd(0.2˜2 nm)]n/Co(0.2˜2 nm) or [Co(0.2˜2 nm)/Pd(0.2˜2 nm)]n/CoPt. A laminated number n is preferably from 1 to 9. The total film thickness is the order of 1˜40 nm. Furthermore, a CoFe alloy with a high Co concentration and a CoFe alloy containing Al, Si, Cr, Ge and Mn as additive elements are available. The saturation magnetization is reduced lower than that of the CoFe alloy and the spin polarizability increases. They are suitable for generating spin polarized electrons.

The intermediate layer 113a can be based on non-magnetic material having high spin permeability such as Cu. This enables spin torque oscillation characterstics to be maintained and exchange coupling between the oscillation layer 116 and the spin injection layer 114 to reduce. The thickness is preferably 0.2˜5 nm.

The saturation magnetic flux density Bs of the bias layers 112a and 112b is characteristically higher than the saturation magnetic flux density of the oscillation layer 114 and the spin injection layer 116. Bs>2.0 T is preferable. Materials can be based on a FeCo alloy (Fe: 30˜100 at %) with a bcc structure, Co/Pd artificial lattice with a hcp structure where a Co layer exists at the interface with the intermediate layer 113b or 113c, a CoPt alloy with a hcp structure and Co with a hcp structure. The film thickness is preferably 115 nm.

The intermediate layer 113b is a layer for adjusting an exchange coupling magnetic field between the oscillation layer 114 and the bias layer 112a, and the intermediate layer 113c is a layer for adjusting an exchange coupling magnetic field between the spin injection layer 116 and the bias layer 112b. Both are preferably materials such as Ta which disturb spin polarized information and break spin torque transfer. Additionally, Nb, Ti, Cr, Zr, Hf, Ru, Rh, Pd can be used. When the magnetization in the oscillation layer oscillates in high-frequency in response to the spin torque transfer by electrons from the spin injection layer, placing the intermediate layer 113b is greatly effective for suppression of variation of the magnetization in the bias layer 112a due to the exchange coupling between the oscillation layer 114 and the bias layer 112a. The intermediate layer 113c can be omitted, because the magnetization in the spin injection layer 116 is hard to move compared with the oscillation layer 114. When the bias layer 112a of high Bs has enough magnetic stability, that is, magnetic anisotropy, the intermediate layer 113b can be also omitted. The exchange coupling magnetic field can be adjusted by the film thicknesses of the intermediate layers 113b and 113c. The thickness is preferably 0.2˜2 nm.

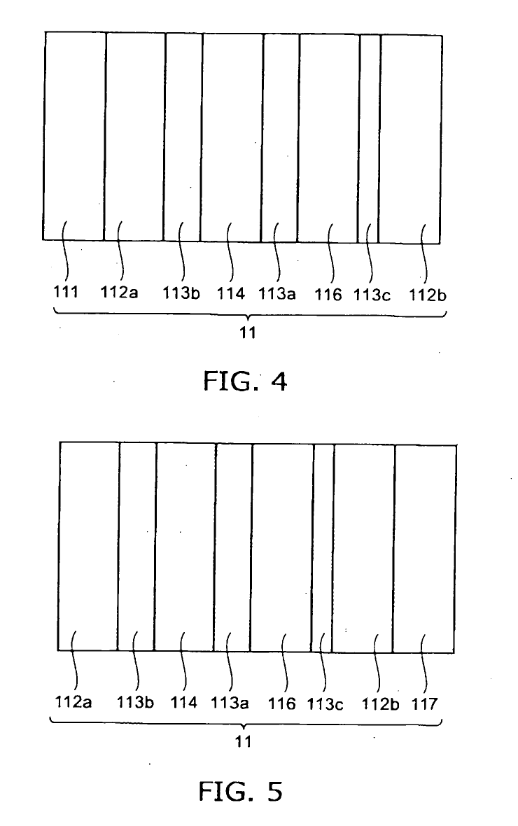

FIGS. 4 and 5 are schematic views illustrating the structure of a laminated body of the spin torque oscillator 11 laminating an auxiliary bias layer 111 or 117 (fifth magnetic layer) on the spin torque oscillator 11 shown in FIG. 3.

The auxiliary bias layer 111 is further laminated on the bias layer 112a and the auxiliary bias layer 117 is further laminated on the bias layer 112b.

The bias layers 111 and 117 characteristically have a higher magnetic anisotropy than the bias layers 112a and 112b. Ku>1×10⁶ erg/cm³ is preferable.

Materials can be based on a FePt alloy, a CoSm alloy and a CoPt alloy and the like. Moreover, a laminated film of [Co/Pd]n can be used. In this case, the film thickness of Co allows the magnetic anisotropy control. Furthermore, CoCrPtO oxide shaped like a fine particle can be used and allows high magnetic anisotropy to be obtained. The thickness is preferably 5˜40 nm.

A combination of the auxiliary bias layer 117 and the bias layer 112a or a combination of the auxiliary bias layer 111 and the bias layer 112b allows a bias layer having high saturation magnetization generating a high saturation magnetic flux density and having high magnetic anisotropic energy generating high coercivity to be obtained. This can add a high strength bias magnetic field which has not been realized by a conventional bias layer having small Bs to the oscillation layer 114 and suppress disturbance of the magnetization direction of the bias layer due to effects of the magnetic field from the main magnetic pole 61. As a result, it becomes possible to achieve stable oscillation characteristics while holding the effective magnetic field applied to the oscillation layer 114 high.

Therefore, according to the embodiment of the invention, a high strength bias magnetic field applied to the oscillation layer 114 from the bias layer 112a with a high saturation magnetic flux density enables to generate a high-frequency magnetic field, allowing the magnetization of the bias layer to be stabilized by the auxiliary bias layer 111 having high magnetic anisotropy. As a result, it is possible to supply a magnetic recording head enabling stable high-frequency assisted magnetic recording.

In this embodiment, while description is made about the case where the auxiliary bias layer 111 is laminated to the bias layer 112a on the oscillation layer 114 side and the case where the auxiliary bias layer 117 is laminated to the bias layer 112b on the spin injection layer 116 side, respectively, both the auxiliary bias layers 111 and 117 may be laminated.

In the configuration described in FIG. 3 to FIG. 5, the shield 62 shown in FIG. 1 is not used. When the shield is not used, there is an advantage in reducing disturbance of an oscillation frequency by suppressing a magnetic field applied to the spin torque oscillator 11 from the main magnetic pole 61 to stabilize the magnetization of the bias layer.

On the other hand, providing the shield 62 taking in the magnetic field from the main magnetic pole 61 has an advantage in generating an oblique magnetic field to realize magnetization reversal more easily.

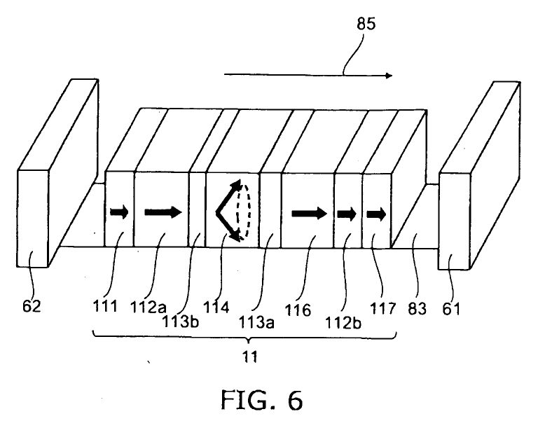

FIG. 6 is a perspective view showing the schematic configuration of the spin torque oscillator 11 according to this embodiment provided with the shield 62.

It is possible to optimize the magnetic field applied to the spin torque oscillator 11 by adjusting a distance between the main magnetic pole 61 and the shield 62 and the shape of the main magnetic pole 61. When the main magnetic pole 61 is far from the shield 62, the magnetic field from the main magnetic pole is perpendicular in the medium, however, shortening the distance generates the oblique magnetic field to the perpendicular direction in the medium, allowing the magnetization reversal of the medium under a lower magnetic field to be realized more easily.

The spin torque oscillator 11 can be provided on either the trailing side or the leading side of the main magnetic pole 61. This is because the medium magnetization is not reversed by the recording magnetic field of the main magnetic pole 61 alone, but is reversed only in the region where the high-frequency magnetic field of the spin torque oscillator 11 is superposed on the recording magnetic field of the main magnetic pole 61.

In this embodiment, the shield 62 is placed on the leading side of the main magnetic pole 61, and the spin torque oscillator 11 is placed between the main magnetic pole 61 and the shield 62. The side surface of the main magnetic pole 61 and the shield 62 is perpendicular to the lamination direction of the spin torque oscillator 11, and the spin injection layer 116 and the oscillation layer 114 are magnetized parallel to the lamination direction, i.e., in the direction from the main magnetic pole 61 to the shield 62 or in the opposite direction.

The laminated body of the spin torque oscillator 11 is illustratively laminated in the order of the auxiliary bias layer 111, the bias layer 112a, the intermediate layer 113b, the oscillation layer 114, the intermediate layer 113, spin injection layer 116, the bias layer 112b and the auxiliary layer 117 from the shield 62 side.

Providing the shield 62 on the opposite side of the main magnetic pole 61 to dispose the spin torque oscillator 11 between the main magnetic pole 61 and the shield 62 enables the magnetic field oblique from the perpendicular direction to the medium facing surface to superpose on the high-frequency magnetic field, allowing recording on the medium with high coercivity.

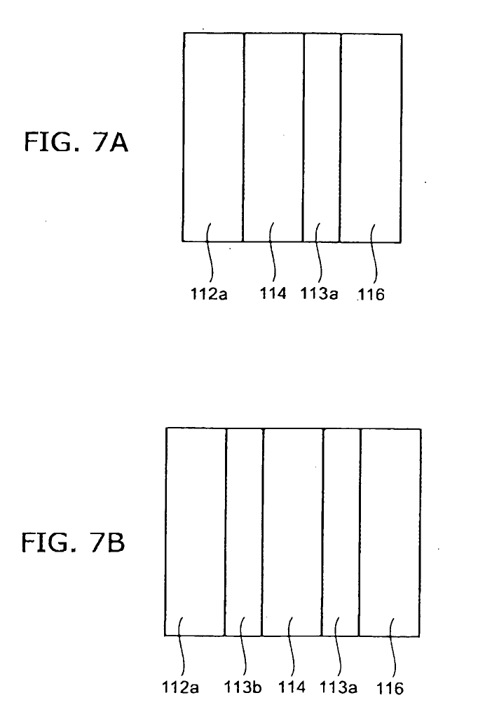

FIG. 7 are schematic views illustrating the structure of a laminated body of a spin torque oscillator 11 according to a comparative example.

FIG. 7A shows lamination of the bias layer 112a and the oscillation layer 114. The exchange coupling magnetic field with the bias layer 112a is added to the oscillation layer 114 to increase the effective magnetic field of the oscillation layer 114, however, variation of the magnetization of the oscillation layer 114 by the spin torque from the spin injection layer 116 results in variation of the magnetization of the bias layer 112a.

Furthermore, as shown in FIG. 7B, if the intermediate layer 113b is inserted to weaken the coupling magnetic field so as not to vary the magnetization of the bias layer, the effective magnetic field applied to the oscillation layer 114 is reduced and the oscillation frequency is decreased, because conventionally a bias layer with preference to high Ku and sacrifice of Bs is used.

Next, a second embodiment of the invention will be described.

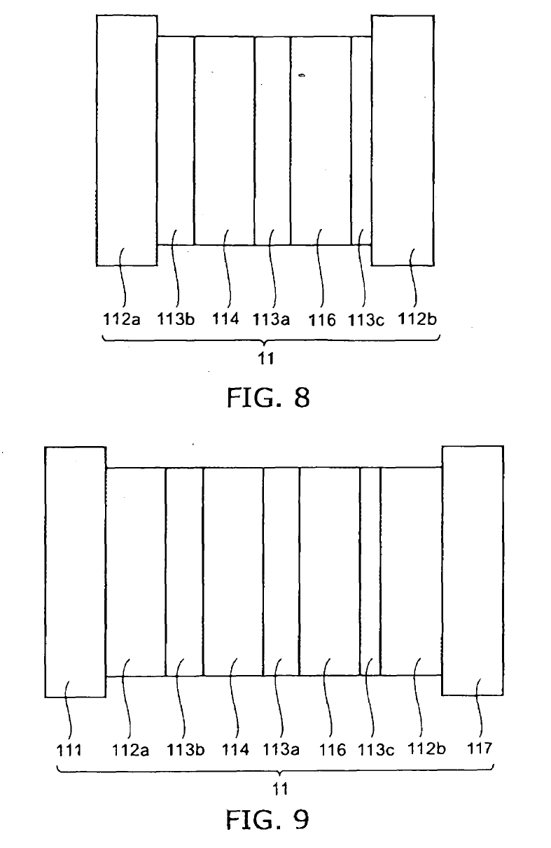

FIG. 8 and FIG. 9 are schematic views illustrating the structure of a laminated body of a spin torque oscillator 11 according to the second embodiment of the invention.

In FIG. 8, film areas of the bias layers 112a and 112b are larger than that of the oscillation layer 114 or the spin injection layer 116.

In FIG. 9, film areas of the auxiliary bias layers 111 and 117 are larger than that of the oscillation layer 114 or the spin injection layer 116.

Only magnetic field generating part is made of high Bs material and the area of remaining part is broadened, thus it is possible to achieve a more stable oscillation characteristic.

As for the bias layer and the auxiliary bias layer, the case where a pair of them has a large film area is described, however, only one of them may have a large film area.

Next, a third embodiment of the invention will be described.

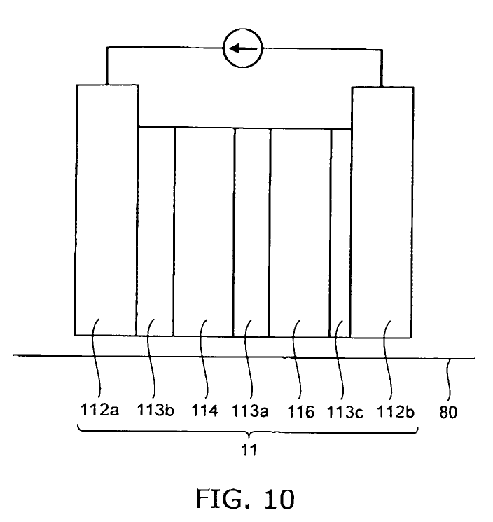

FIG. 10 is a schematic view illustrating the structure of a laminated body of a spin torque oscillator 11 according to the third embodiment of the invention.

The bias layers 112a and 112b characteristically serve as electrodes, and particularly have a shape being long in a direction with the distance from the medium facing surface. This realize the bias layers 112a and 112b serving as the electrodes more easily. Here, the auxiliary bias layers 111 and 117 may serve as the electrodes. Flowing a driving current with a prescribed value through the spin torque oscillator 11 via the bias layers 112a and 112b or the auxiliary bias layers 111 and 117 serving as the electrodes makes it possible to apply a high-frequency magnetic field with an enough strength to the recording medium 80 from the spin torque oscillator 11, and it becomes possible to record onto the medium having high coercivity which is difficult to record without the high-frequency magnetic field by applying a recording magnetic field with the high-frequency magnetic field from the main magnetic pole 61 adjacent to the spin torque oscillator 11.

Here, while description is made about the case where a pair of the bias layer and the auxiliary bias layer is provided, it does not always need to provide a pair of the bias layer and the auxiliary bias layer, for example, the bias layer 112a and the auxiliary bias layer 117 or the auxiliary bias layer 111 and the bias layer 112b may be provided and serve as a pair of electrodes.

Next, a magnetic recording apparatus according to an embodiment of the invention is described. More specifically, the magnetic recording head 5 of the invention described with reference to FIGS. 1-6 and 8-10 is illustratively incorporated in an integrated recording-reproducing magnetic head assembly, which can be installed on a magnetic recording/reproducing apparatus.

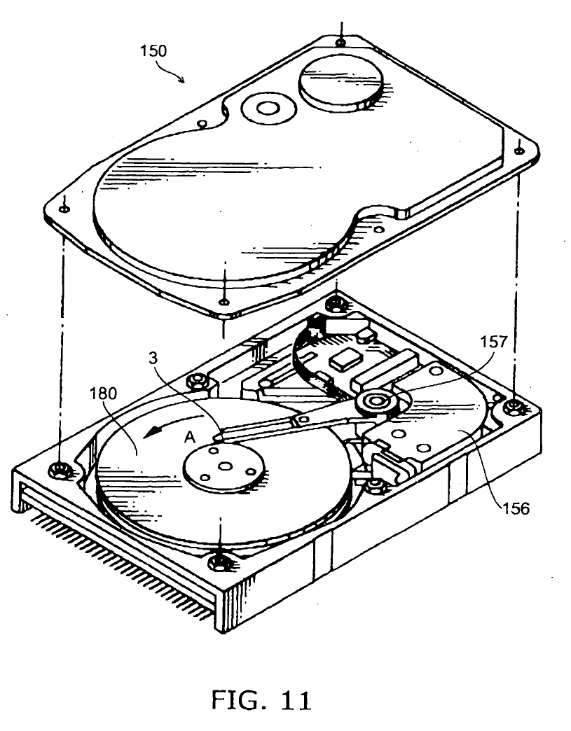

FIG. 11 is a principal perspective view illustrating the schematic configuration of such a magnetic recording/reproducing apparatus.

More specifically, the magnetic recording/reproducing apparatus 150 of the invention is an apparatus based on a rotary actuator. In this figure, a recording medium disk 180 is mounted on a spindle 152 and rotated in the direction of arrow A by a motor, not shown, in response to a control signal from a drive controller, not shown. The magnetic recording/reproducing apparatus 150 of the invention may include a plurality of medium disks 180.

A head slider 3 for recording/reproducing information stored on the medium disk 180 has a configuration as described above with reference to FIG. 2 and is attached to the tip of a thin-film suspension 154. Here, a magnetic recording head according to any one of the above embodiments is illustratively installed near the tip of the head slider 3.

When the medium disk 180 is rotated, the air bearing surface (ABS) 100 of the head slider 3 is held at a prescribed floating amount from the surface of the medium disk 180. Alternatively, it is also possible to use a slider of the so-called “contact-traveling type”, where the slider is in contact with the medium disk 180.

The suspension 154 is connected to one end of an actuator arm 155 including a bobbin for holding a driving coil, not shown. A voice coil motor 156, which is a kind of linear motor, is provided on the other end of the actuator arm 155. The voice coil motor 156 is composed of the driving coil, not shown, wound up around the bobbin of the actuator arm 155 and a magnetic circuit including a permanent magnet and an opposed yoke disposed so as to sandwich the coil therebetween.

The actuator arm 155 is held by ball bearings, not shown, provided at two positions above and below the spindle 157, and can be slidably rotated by the voice coil motor 156.

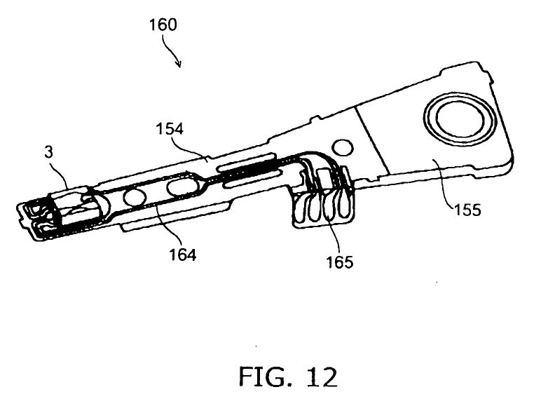

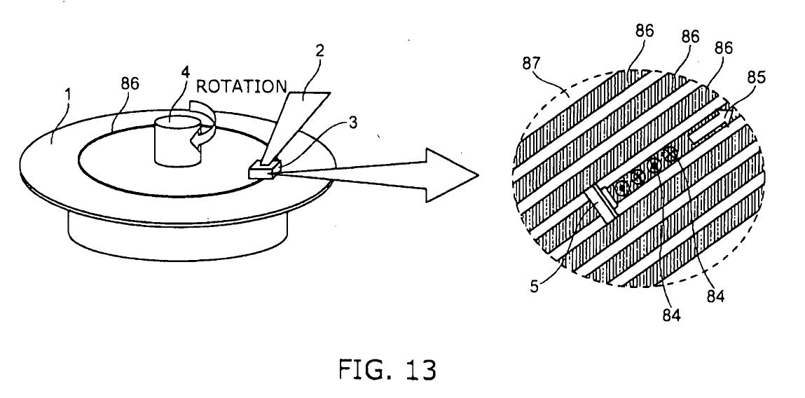

FIG. 12 is an enlarged perspective view of the magnetic head assembly 160 ahead of the actuator arm 155 as viewed from the disk side. More specifically, the magnetic head assembly 160 has an actuator arm 155 illustratively including a bobbin for holding a driving coil, and a suspension 154 is connected to one end of the actuator arm 155.

To the tip of the suspension 154 is attached a head slider 3 including any one of the magnetic recording heads 5 described above with reference to FIGS. 1-6, 8-10. The suspension 154 has a lead 164 for writing and reading signals. The lead 164 is electrically connected to each electrode of the magnetic head incorporated in the head slider 3. In the figure, the reference numeral 165 denotes an electrode pad of the magnetic head assembly 160.

According to the invention, by using the magnetic recording head as described above with reference to FIGS. 1-6, 8-10, it is possible to reliably record information on the perpendicular magnetic recording medium disk 180 with higher recording density than conventional. Here, for effective microwave assisted magnetic recording, preferably, the resonance frequency of the medium disk 180 to be used is nearly equal to the oscillation frequency of the spin torque oscillator 11.

FIG. 13 is a schematic view illustrating a magnetic recording medium that can be used in this embodiment.

More specifically, the magnetic recording medium 1 of this embodiment includes perpendicularly oriented, multiparticle magnetic discrete tracks 86 separated from each other by a nonmagnetic material (or air) 87. When this medium 1 is rotated by a spindle motor 4 and moved toward the medium moving direction 85, a recording magnetization 84 can be produced by the magnetic recording head 5 described above with reference to FIGS. 1-6, 8-10.

By setting the width (TS) of the spin torque oscillator 11 in the width direction of the recording track to not less than the width (TW) of the recording track 86 and not more than the recording track pitch (TP), it is possible to significantly prevent the decrease of coercivity in adjacent recording tracks due to leaked high-frequency magnetic field from the spin torque oscillator 11. Hence, in the magnetic recording medium 1 of this example, only the recording track 86 to be recorded can be effectively subjected to microwave assisted magnetic recording.

According to this embodiment, a microwave assisted magnetic recording apparatus with narrow tracks, i.e. high track density, is realized more easily than in the case of using a multiparticle perpendicular medium made of the so-called “blanket film”. Furthermore, by using the microwave assisted magnetic recording scheme and using a magnetic medium material with high magnetic anisotropy energy (Ku) such as FePt or SmCo, which cannot be written by conventional magnetic recording heads, magnetic medium particles can be further downscaled to the size of nanometers. Thus it is possible to realize a magnetic recording apparatus having far higher linear recording density than conventional also in the recording track direction (bit direction).

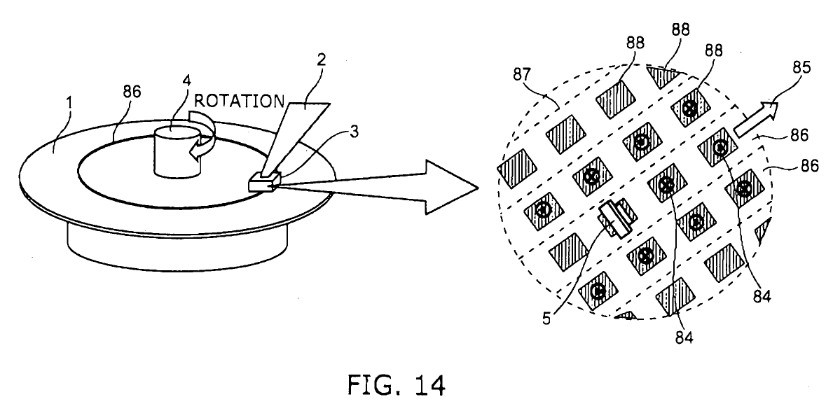

FIG. 14 is a schematic view illustrating another magnetic recording medium that can be used in this embodiment.

More specifically, the magnetic recording medium 1 of this example includes magnetic discrete bits 88 separated from each other by a nonmagnetic material 87. When this medium 1 is rotated by a spindle motor 4 and moved toward the medium moving direction 85, a recording magnetization 84 can be produced by the magnetic recording head 5 described above with reference to FIGS. 1-6, 8-10.

According to the invention, as shown in FIGS. 13 and 14, recording can be reliably performed also on the recording layer having high coercivity in a discrete-type magnetic recording medium 1, allowing magnetic recording with high density and high speed.

Also in this example, by setting the width (TS) of the spin torque oscillator 11 in the width direction of the recording track to not less than the width (TW) of the recording track 86 and not more than the recording track pitch (TP), it is possible to significantly prevent the decrease of coercivity in adjacent recording tracks due to leaked high-frequency magnetic field from the spin torque oscillator 11. Hence only the recording track 86 to be recorded can be effectively subjected to microwave assisted magnetic recording. According to this example, by downscaling the magnetic discrete bit 88 and increasing its magnetic anisotropy energy (Ku), there is a possibility of realizing a microwave assisted magnetic recording apparatus having a recording density of 10 Tbits/inch² or more as long as thermal fluctuation resistance under the operating environment can be maintained.

The embodiments of the invention have been described with reference to the examples. However, the invention is not limited to the above examples. For instance, two or more of the examples described above with reference to FIGS. 1-6 and 8-14 can be combined as long as technically feasible, and such combinations are also encompassed within the scope of the invention.

That is, the invention is not limited to the examples, but can be practiced in various modifications without departing from the spirit of the invention, and such modifications are all encompassed within the scope of the invention.

1. A magnetic recording head comprising:
a main magnetic pole; and
a laminated body including:
a first magnetic layer,
a second magnetic layer,
a first intermediate layer provided between the first magnetic layer and the second magnetic layer, and
a third magnetic layer laminated with the first and second magnetic layers and the first intermediate layer, the third magnetic layer exerting a magnetic field on at least any of the first magnetic layer and the second magnetic layer,
the third magnetic layer having larger saturation magnetization than at least any of the first magnetic layer and the second magnetic layer.

2. The head according to claim 1, wherein the laminated body further includes a fifth magnetic layer provided opposite to the first magnetic layer and the second magnetic layer viewed from the third magnetic layer, having larger magnetic anisotropy than the third magnetic layer.

3. The head according to claim 1, wherein the third magnetic layer has a larger film area than the first magnetic layer, and the third magnetic layer has the larger film area than the second magnetic layer.

4. The head according to claim 2, wherein the fifth magnetic layer has a larger film area than the third magnetic layer.

5. The head according to claim 2, wherein the fifth magnetic layer serves as an electrode.

6. The head according to claim 1, further comprising a shield sandwiching the laminated body between the shield and the main magnetic pole.

7. A magnetic recording head comprising:
a main magnetic pole; and
a laminated body including a first magnetic layer, a second magnetic layer, a first intermediate layer provided between the first magnetic layer and the second magnetic layer, and a third magnetic layer and a fourth magnetic layer provided to sandwich the first magnetic layer and the second magnetic layer on both sides,
the third magnetic layer and the fourth magnetic layer having larger saturation magnetization than at least any of the first magnetic layer and the second magnetic layer.

8. The head according to claim 7, wherein the laminated body further includes a fifth magnetic layer provided opposite to the first magnetic layer and the second magnetic layer viewed from the third magnetic layer, having larger magnetic anisotropy than the third magnetic layer.

9. The head according to claim 7, wherein the laminated body further includes a fifth magnetic layer provided opposite to the first magnetic layer and the second magnetic layer viewed from the fourth magnetic layer, having larger magnetic anisotropy than the fourth magnetic layer.

10. The head according to claim 8, wherein the fifth magnetic layer has a larger film area than the third magnetic layer.

11. The head according to claim 7, wherein the third magnetic layer and the fourth magnetic layer serve as an electrode.

12. The head according to claim 8, wherein the fifth magnetic layer serves as an electrode.

13. The head according to claim 7, further comprising a shield sandwiching the laminated body between the shield and the main magnetic pole.

14. A magnetic recording apparatus comprising:
a magnetic recording medium;
a magnetic recording head including:
a main magnetic pole; and
a laminated body including:
a first magnetic layer,
a second magnetic layer,
a first intermediate layer provided between the first magnetic layer and the second magnetic layer, and
a third magnetic layer laminated with the first and second magnetic layers and the first intermediate layer, the third magnetic layer exerting a magnetic field on at least any of the first magnetic layer and the second magnetic layer,
the third magnetic layer having larger saturation magnetization than at least any of the first magnetic layer and the second magnetic layer;
a moving mechanism configured to allow relative movement between the magnetic recording medium and the magnetic recording head which are opposed to each other with a spacing therebetween or in contact with each other;
a controller configured to position the magnetic recording head at a prescribed recording position of the magnetic recording medium; and
a signal processing unit configured to perform writing and reading of a signal on the magnetic recording medium by using the magnetic recording head.

15. The apparatus according to claim 14, wherein the laminated body further includes a fifth magnetic layer provided opposite to the first magnetic layer and the second magnetic layer viewed from the third magnetic layer, having larger magnetic anisotropy than the third magnetic layer.

16. The apparatus according to claim 14, wherein the laminated body is provided on the trailing side of the main magnetic pole.

17. The apparatus according to claim. 14, wherein the laminated body is provided on the leading side of the main magnetic pole.

18. The apparatus according to claim 14, wherein the magnetic recording medium is a discrete track medium in which adjacent recording tracks are formed via a nonmagnetic member.

19. The apparatus according to claim 14, wherein the magnetic recording medium is a discrete bit medium in which magnetic recording dots isolated by a nonmagnetic member are regularly arranged.

20. A magnetic recording apparatus comprising:
a magnetic recording medium;
a magnetic recording head including:
a main magnetic pole; and
a laminated body including a first magnetic layer, a second magnetic layer, a first intermediate layer provided between the first magnetic layer and the second magnetic layer, and a third magnetic layer and a fourth magnetic layer provided to sandwich the first magnetic layer and the second magnetic layer on both sides,
the third magnetic layer and the fourth magnetic layer having larger saturation magnetization than at least any of the first magnetic layer and the second magnetic layer; a moving mechanism configured to allow relative movement between the magnetic recording medium and the magnetic recording head which are opposed to each other with a spacing therebetween or in contact with each other;
a controller configured to position the magnetic recording head at a prescribed recording position of the magnetic recording medium; and
a signal processing unit configured to perform writing and reading of a signal on the magnetic recording medium by using the magnetic recording head.
